(19) United States
(12) Patent Application Publication
(10) Pub. No.: US 2021/0229812 A1
(43) Pub. Date: Jul. 29, 2021

(54) INTERIOR SPACE MANAGEMENT SYSTEM FOR AN AIRCRAFT, AIRCRAFT HAVING SAID INTERIOR SPACE MANAGEMENT SYSTEM, AND METHOD FOR CONTROLLING SAID INTERIOR SPACE MANAGEMENT SYSTEM

(71) Applicant: Diehl Aerospace GmbH, Ueberlingen (DE)

(72) Inventors: Lothar TRUNK, Weibersbrunn (DE); Marcel SCHMEDES, Woellstadt (DE); Gooneshwaree HURRY, Frankfurt am Main (DE)

(73) Assignee: Diehl Aerospace GmbH, Ueberlingen (DE)

(21) Appl. No.: 17/155,597

(22) Filed: Jan. 22, 2021

(30) Foreign Application Priority Data
Jan. 23, 2020 (DE) 102020000373.7

(51) Int. Cl. B64D 11/00; G05B 13/02; B64D 47/08; B64D 11/06

(52) U.S. Cl. CPC B64D 11/00; G05B 13/0265; B64D 11/06; B64D 47/08; B64D 11/003

(57) ABSTRACT

In passenger aeroplanes, baggage compartments for holding passengers' baggage are usually arranged above the rows of seats. The present invention proposes an interior space management system which is characterized by improved management of the aeroplane interior. For this purpose, an interior space management system (1) for an aircraft (2) is proposed, the aircraft (2) having a stowage compartment arrangement (6), the stowage compartment arrangement (6) having a plurality of stowage compartment sections (7), each for holding one or more baggage items (8), and having a control unit (16), the control unit (16) being designed to control and/or manage a distribution of interior regions of an interior space (3) of the aircraft (2), and the control unit (16) being designed to control and/or manage an occupancy of the stowage compartment sections (7) on the basis of historical data of the aircraft (2) and/or on the basis of baggage data of the baggage items (8).

### BACKGROUND OF THE INVENTION

The present invention is directed to an interior space management system for an aircraft, an aircraft having the interior space management system and a method for controlling the interior space management system.

### DISCUSSION OF THE PRIOR ART

In passenger aeroplanes, baggage compartments for holding passengers' baggage are usually arranged above the rows of passenger seats. Various systems are known for monitoring the level of occupancy of baggage compartments. In addition, systems for controlling access to individual baggage compartments are known. For example, such systems can be used to monitor and/or control the baggage compartments, for example, to implement a reservation system for individual baggage compartments.

For example, US Publication No. 2015083858 Al discloses a method for utilizing a plurality of overhead bins in a passenger cabin of an aeroplane, comprising the steps:
dividing each of the overhead bins into multiple stowage spaces, wherein a number of stowage spaces for each overhead bin is equal to at least a number of passenger seats within a seat row,
designating a space number to each of the stowage spaces to form a numbered space, wherein each of the space numbers is the same as an assigned seat number within the row of seats,
assigning a passenger with the assigned seat number so that the passenger is assigned to the corresponding numbered space;
controlling access to the numbered space, so that only a member of cabin crew or the passenger with the assigned seat number can open and close the numbered space.

### SUMMARY OF THE INVENTION

Accordingly, the present invention is directed to an interior space management system which is characterized by improved management of the aircraft interior space.

More particularly, the present invention is directed to an interior space management system for an aircraft, wherein the aircraft has a stowage compartment arrangement, wherein the stowage compartment arrangement has a plurality of stowage compartment sections, each holding one or more baggage items, having a control unit wherein the control unit is designed to control and/or manage a distribution of interior regions of an interior space of the aircraft, and wherein the control unit is designed to control and/or manage an occupancy of the stowage compartment sections as interior regions on the basis of historical data of the aircraft and/or on the basis of baggage data of the baggage items.

Further, the present invention is directed to an aircraft having the interior space management system of the present invention.

Still further, the present invention is directed to a method for controlling the interior space management system of the present invention, in which a distribution of the interior space regions of the interior space of the aircraft is controlled and/or managed by means of the control unit, wherein on the basis of the historical data of the aircraft and/or on the basis of the baggage data of the baggage items, an occupancy of the stowage compartment sections of the stowage compartment arrangement is controlled and/or managed by the control unit.

More particularly, the present invention is directed to an interior space management system which is designed and/or suitable for an aircraft. The interior space management system is used, in particular, for the management and/or assignment of interior regions of an aircraft interior space. The interior space is preferably defined by a cabin of the aircraft.

The aircraft has a stowage compartment arrangement with multiple stowage compartment sections, each of which is designed and/or suitable for holding one or more items of baggage. Preferably, all or at least some of the interior regions are formed as the stowage compartment sections. In particular, the stowage compartment arrangement is located in an overhead section of the cabin, preferably above a seating area. The seating area is preferably divided into at least two or more groups of seat rows, a separate stowage compartment arrangement being provided for each group of seat rows. The stowage compartment sections can be implemented as individual stowage spaces and/or stowage compartments separate from one another.

The interior space management system has a control unit designed to control and/or manage a distribution of the interior regions of the aircraft. The control unit is preferably designed to assign one or more interior regions to one or more transported goods, such as baggage, cargo, etc., and/or to one or more persons, such as passengers, crew, etc. In particular, an interior space distribution is thus to be understood to mean the distribution and/or assignment of interior regions by the control unit. Specifically, the control unit can perform the interior space management during the boarding and/or disembarking process. The control unit can be arranged centrally in the aircraft. Alternatively, the control unit can also have a distributed arrangement, wherein the control unit and the aircraft are connected to each other for signal communication.

In accordance with the present invention, the control unit is designed to control and/or manage the occupancy of the interior regions, in particular the stowage compartment sections, on the basis of historical data from the aircraft. “Historical data” means previous data that has been recorded and/or stored in the past before and/or during and/or after a flight or flight segment.

As an alternative or as an additional option, the control unit is designed to control and/or manage the occupancy of the interior regions, in particular the stowage compartment sections, on the basis of baggage data of the baggage items. Baggage data can include both previous and current baggage data, which is captured in particular before the flight, particularly before boarding. Preferably, the previous baggage data can also be used as historical data. The control unit is particularly preferably designed to assign a stowage compartment section to one or more persons based on the historical data and/or on the baggage data as a result.

In particular, the control unit controls a display device which is designed and/or suitable for displaying vacant and/or occupied interior regions, in particular stowage compartment sections. In particular, the display can be used to guide passengers in the cabin, in particular to the associated stowage compartment sections. For example, the display device can be designed as a display located in the cabin, e.g. an “OHSC binbasse panel LCD”. Alternatively, the display device can also be formed by a personal data processing unit, e.g. a passenger's smartphone. For example, the personal data processing unit is designed to display the result, e.g. of a booking process, in a browser. The display device is primarily used to display the occupancy information and optionally to display a personal indicator, such as a symbol, name or seat number of the passenger, or the like. Alternatively or in addition, the interior space management system has an output device, such as a printer, which outputs the allocation of the interior regions, in particular the stowage compartment sections.

An advantage of the present invention is in particular that the interior management system implements an optimized allocation of interior regions, thereby achieving an improved management of the aircraft interior space. Another advantage is that baggage compartment utilization and/or load distribution in the cabin of the aircraft can be easily optimized. Thus, for example, the boarding or disembarkation process can be accelerated or improved, taking into account an optimal distribution of the interior regions.

In a specific implementation, it is provided that the historical data comprise occupancy information of the individual stowage compartment sections on previous flights. In particular, the occupancy information may include indicators for the occupancy status and/or occupancy level and/or volume and/or weight utilization and/or distribution, as a function of the interior regions, in particular the stowage compartment arrangement, preferably the individual stowage compartment sections. In particular, one or more items of occupancy information can be recorded over time and stored as the historical data.

Alternatively or optionally, the historical data comprise flight information of the aircraft. The historical data may comprise general and/or passenger-dependent flight information. In particular, the general flight information may include information about the flight distance, date, time of day, duration, number of passengers, status of passengers, general baggage data, correlated flight data, general time and/or efficiency of disembarkation/boarding. In particular, the passenger-dependent flight information can include information about the personal passenger status, usual piece of baggage for similar flight distances, personal weight and/or volume utilization, personal baggage data, personal time and/or efficiency of disembarkation/boarding.

In a further specific implementation, the interior space management system has an acquisition unit that is designed and/or suitable for capturing the occupancy information of one, some or all of the stowage compartment sections. In particular, the acquisition unit comprises one or more sensor devices that are designed and/or suitable for capturing the occupancy information of one or more of the stowage compartment sections. Preferably, the sensor device is designed as an optical sensor. Designed as an optical sensor, the sensor device is used to monitor one or more adjacent stowage compartment sections in an acquisition region. The optical sensor can be a camera, in particular a TOF camera. Alternatively, the sensor device, or optionally another sensor device, can be designed as a weight sensor, e.g. a load cell. Designed as a weight sensor, the sensor device or the other sensor device is used to record a weight of one or more stowage compartment sections connected to each other.

According to this specific implementation, the acquisition unit is connected to the control unit for signal communication purposes in order to transmit the occupancy information. Preferably, the control unit is designed to generate an output signal based on the acquired occupancy information and/or to control the stowage compartment sections to indicate which stowage compartment sections are occupied and/or which ones still have free capacity. Optionally, the control unit is used to determine a loading state of the individual stowage compartment sections on the basis of the acquired occupancy information, preferably before the aircraft takes off, in relation to a permissible gross weight and/or permissible total volume, and to output an additional output signal if either of these is exceeded. In particular, the control unit is designed to control the display device and/or the output device on the basis of the output signal and, optionally, the additional output signal.

In another embodiment it is provided that the interior space management system has a memory unit for storing the historical data. For this purpose, the associated historical data and optionally the baggage data for each flight are stored and/or can be stored in the memory unit. For example, the memory unit may be implemented as an online-based memory, such as a cloud, or a local data medium. In particular, the corresponding flight information and/or occupancy information and/or the baggage data for each flight can be stored in the memory unit as a joint data record. The memory unit is connected to the control unit for signal communication for the transmission of the historical data. As an online-based memory, the memory unit can be connected to the control unit wirelessly, in particular via a network, preferably via the internet. Designed as a local data medium, the memory unit can be connected to the control unit wirelessly or by cables and/or via conductor tracks. The acquisition unit, the control unit and the memory unit are particularly preferably connected to each other for signal and/or data communication. Thus, the occupancy information recorded by the acquisition unit can be either processed by the control unit in real time, or stored in the memory unit and, if necessary, processed by the control unit at a later time.

In a further specific implementation it is provided that the interior space management system contains at least one data processing unit, in particular as the personal data processing unit, which is designed and/or suitable for capturing baggage item information of baggage item to be stowed and for providing the baggage item information as the baggage data. The data processing unit is used in particular for the contactless and/or optical acquisition of the baggage item information. The data processing unit can particularly preferably capture the baggage item information using imaging and/or video technology. In particular, the baggage item information captured by the data processing unit comprises geometric dimensions of the baggage item, such as height, width and depth of the baggage item. Optionally, the baggage data can comprise further baggage item information, such as the number, weight, type of the baggage item.

According to this specific implementation, for the transmission of the baggage data the data processing unit is and/or can be connected to the control unit and optionally to the memory unit for signal communication purposes. In particular, the data processing unit and the control unit and optionally the memory unit are and/or can be connected to each other via a network, preferably via the internet. In principle, the data processing unit itself can process the baggage item information and transmit it directly to the control unit. Alternatively, the data processing unit can transmit the baggage item information to the data processing unit indirectly via the memory unit, wherein the baggage item information in the memory unit is evaluated and/or consolidated with other data, in particular the historical data.

In a specific implementation, it is provided that the data processing unit has a camera. The camera is designed to record the baggage item information as an image file. To this end, the camera can preferably photograph the baggage item. Preferably, the camera is implemented as a digital camera. In particular, the data processing unit transmits the image file to the memory unit as raw data. Alternatively, the image file is evaluated directly in the data processing unit.

In an extension, either the data processing unit or the memory unit has a software module, wherein the software module is designed to determine a dimension of the baggage item as baggage item information by means of an evaluation of the image file. In particular, the software module is an application software for interpreting the image file. In particular, the software module is used for digital image processing of the image file. The software module is preferably designed and/or suitable for controlling the camera. Preferably, the software module controls the camera until all relevant views of the baggage item have been fully scanned. It may also be provided that further baggage item information can be entered into the software module via an input and transferred to the control unit and/or the memory unit together with the baggage item information as baggage data.

In a further design, the data processing unit is designed as a portable data processing unit. In particular, a portable data processing unit shall be understood to mean any mobile, portable and/or hand-held device which is designed to record an image file of the baggage item, preferably by means of the camera. The portable data processing unit is preferably implemented as a smartphone or a tablet. Thus, the customer/passenger can easily capture the current baggage size of the baggage item, wherein the baggage item information thereby obtained can then be taken into account for optimizing the check-in or boarding process.

In an extension it is provided that the interior space management system has an analysis module which is designed and/or suitable for determining the utilization of the aircraft on the basis of the historical data and/or the baggage data. In particular, the analysis module is designed to determine the utilization of the individual stowage compartment sections on the basis of the historical data and the baggage data. In particular, the analysis module is designed to determine a usage profile of the individual stowage compartment sections, on the basis of the historical data and the baggage data. The analysis module preferably contains a stored algorithm that calculates a utilization of the aircraft and/or the stowage compartment arrangement based on the usage profile, in particular depending on flight information, such as flight distance, time of day, etc. Thus, a detailed statement about the utilization of the aircraft can be made by reference to the historical data and/or the baggage data. The analysis module is preferably designed as a software module, preferably an online-based application, in particular a cloud-based application. In principle, the control unit or the memory unit can comprise the analysis module. Alternatively, however, the analysis module can also be implemented in a separate analysis unit, which is and/or can be connected for signal communication purposes to the control unit and/or the data processing unit and the memory unit. For example, the analysis module is designed to analyse the historical data stored in the memory unit and to define inferences, which are then derived or extrapolated to current and/or future data sets by means of a method.

In a further specific implementation, it is provided that the analysis module is designed as an Al module. The Al module is designed to predict a future utilization of the aircraft on the basis of historical data. In particular, the Al module is designed to process and evaluate the historical data and the associated baggage data by means of a neural network. The Al module is preferably designed to make a prediction of the future occupancy of the stowage compartment arrangement, in particular of the individual stowage compartment sections. Optionally, the Al module is designed to learn and/or improve the distribution of baggage items based on baggage size and/or baggage weight in the stowage compartment arrangement, on the basis of the historical data and/or the baggage data. Due to the prediction regarding the utilization of the aircraft, the boarding or disembarkation process can be improved. This leads to an improved cost-effectiveness in the daily operation of the aircraft.

In a further implementation, it is provided that the aeroplane comprises a seating arrangement with a plurality of seats. In particular, the seating arrangement comprises two or more rows of seats to form the groups of seat rows, wherein multiple seats are arranged behind one another in the flight direction in each row. Particularly preferably, one stowage compartment section each is and/or can be assigned to one or more seats. In particular, each seat is and/or can be assigned exactly one stowage compartment section. The control unit is designed to control and/or manage the allocation of the seats based on the historical data and/or the baggage data. In particular, the control unit is designed to control the allocation of the seats based on the baggage item information captured by the data processing unit. In particular, each passenger is assigned exactly one seat and one associated stowage compartment section by the control unit.

In particular, the analysis module is designed to activate the control unit on the basis of the expected utilization and, optionally, on the basis of the current baggage data to optimize the seat distribution and/or baggage item distribution. In particular, the Al module is designed to calculate, on the basis of the baggage data and/or the historical data, an optimal allocation of the stowage compartment sections and/or seats based on the current baggage data and/or historical data and to display them by activating the control unit. For example, the allocation of the stowage compartment sections and/or seats can be optimized until shortly before boarding, wherein the passenger can view his/her optimized seat and/or stowage compartment section via his/her personal data processing unit. In particular, the analysis module is designed to offer a real improvement in the distribution of baggage items and/or seats based on optimization strategies.

Thus, each passenger can be assigned a seat and a corresponding stowage compartment section, eliminating the need for time-consuming searches for vacant seats. In addition, it is possible to optimize seat selection in terms of the space availability of the stowage compartment arrangement and also in terms of the load distribution in the aircraft. Furthermore, this makes it possible for the airline to offer this improved service for a fee in order to optimize the commercial situation in this regard.

As noted above, the present invention further relates to an aircraft having the interior space management system as described earlier. The aircraft is preferably designed as an aeroplane, in particular a transport or passenger aeroplane.

The present invention further relates to a method for controlling the interior space management system as described earlier. In this, a distribution of interior regions of the aircraft is controlled and/or managed by means of the control unit, wherein an occupancy of the stowage compartment sections is controlled and/or managed by the control unit on the basis of the historical data and/or on the basis of the baggage data.

In a specific design, in a first step, a current baggage information of the baggage item can be captured using the data processing unit. One or more pieces of baggage item information of the baggage items, in particular the hand baggage items, is captured by the passenger and/or the crew using the data processing unit and transmitted as baggage data directly to the control unit, or indirectly via the memory unit to the control unit. In a further step, a current occupancy information of the stowage compartment sections is captured using the acquisition unit. A weight and/or occupancy level of the individual stowage compartment sections can be captured by the acquisition unit and transmitted as occupancy information directly to the control unit or indirectly via the memory unit to the control unit. Based on the current baggage information and/or on the current occupancy information, an optimal baggage distribution and/or an optimal boarding time and/or an optimal seat distribution will then be determined by the analysis module and controlled by the control unit. For example, each passenger can be assigned a corresponding seat and/or stowage compartment section by the control unit.

In an alternative or supplementary design, a prediction for future utilization of the aircraft is calculated by the Al module on the basis of the historical data. In this process the Al module can access the historical data stored in the memory unit, in particular past occupancy information and/or flight information and/or baggage data, and create future usage profiles. Preferably, the Al module calculates, based on the historical data, an expected occupancy of the stowage compartment sections and/or seats in relation to the flight information, such as flight distance, time of day, day of the week, month etc. Based on the prediction, an optimal baggage item distribution and/or an optimal boarding time and/or an optimal seat distribution is then determined by the analysis unit and controlled by the control unit. For this purpose, the analysis unit can activate the control unit in order, for example, to assign each passenger a corresponding seat and/or stowage compartment section.

### BRIEF DESCRIPTION OF THE DRAWINGS

Other features, effects and advantages of the invention are derived from the following description of a preferred exemplary embodiment of the invention and from the accompanying figures. In the drawings:

FIG. 1 shows a highly schematized representation of a load distribution system for an aircraft as an exemplary embodiment of the invention;

FIG. 2 shows a flowchart of a method for optimized seat allocation for the load distribution system as a further exemplary embodiment of the invention; and

FIG. 3 shows a further flowchart of a further method for optimizing baggage compartment costs for the load distribution system as a further exemplary embodiment of the invention.

### DETAILED DESCRIPTION OF THE INVENTION

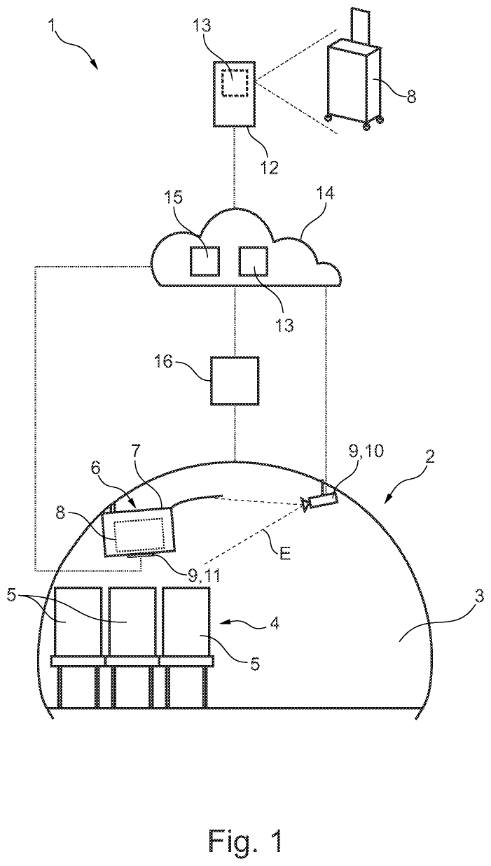

FIG. 1 shows a highly schematized view of an interior space distribution system 1 for an aircraft 2 as an exemplary embodiment of the invention. In the exemplary embodiment shown, a detail of an interior space 3 of the aircraft 2 is shown in a highly simplified representation. For example, the aircraft 2 is designed as a passenger aeroplane, with the interior space 3 being formed as a passenger cabin. The function of the interior space distribution system 1 is to manage and control interior regions of the interior space 3.

A seating arrangement 4 is arranged in the interior space 3. The seating arrangement 4 has a plurality of seats 5 as interior regions, which are arranged one behind another in the longitudinal direction of the aeroplane to form a row of seats in each case. Together, the rows of seats in turn form a group of seat rows, wherein for reasons of clarity the illustrated seating arrangement 4 in the exemplary embodiment shown has only one group of seat rows. However, it is preferred that the seating arrangement 4 can be arranged in any configuration and has at least two groups of seat rows, each having at least one row of seats.

In addition, a stowage compartment arrangement 6 is arranged in the passenger cabin 3, comprising a plurality of stowage compartment sections 7, in particular arranged one behind another in the direction of flight, as further interior regions. The stowage compartment sections 7 are used to hold one or more baggage items 8, e.g. carry-on suitcases. The stowage compartment sections 7 can be defined by individual stowage compartments, also known as bins, arranged one behind the other in the longitudinal direction of the aeroplane. It may be provided that each stowage compartment has one, or alternatively a plurality of, stowage compartment sections 7. For example, each group of seat rows is assigned a separate stowage compartment arrangement 6. For example, each seat 5 may have exactly one stowage compartment section 7 assigned to it.

The interior space distribution system 1 has an acquisition unit 9 which is used to capture the occupancy information of the stowage compartment arrangement 6, in particular the stowage compartment sections 7. The acquisition unit 9 has a plurality of optical sensors 10, wherein, for example, one optical sensor 10 is assigned to one stowage compartment section 7, or at least one stowage compartment. For example, the optical sensor 10 is designed as a camera, in particular as a 3D camera, and is used to monitor a degree of occupancy of the individual stowage compartment sections 7 in an acquisition region E. The optical sensor 10 can be positioned either inside or outside the stowage compartment arrangement 6. Alternatively or as an additional option, the acquisition unit 9 comprises a plurality of weight sensors 11, wherein, for example, one weight sensor 11 is assigned to one stowage compartment section 7, or at least one stowage compartment. For example, the weight sensor 11 is designed as a load cell and is used to detect the weight of the baggage item 8 arranged in the stowage compartment section 7.

The interior space distribution system 1 also has a data processing unit 12, which is used to capture current baggage item information for the baggage item 8. The data processing unit 12 is equipped with a camera for this purpose, in order to record an image file of the baggage item 8 as baggage item information. For example, the baggage item information captured by the camera is used to determine the baggage item size of the baggage item 8. For example, the data processing unit 12 can be designed as a smartphone or tablet, wherein the baggage item 8 can be scanned by the passenger before boarding and can be supplemented, for example, with additional pieces of baggage item information, such as the type of baggage, passenger status, number of baggage items. The data processing unit 12 then provides the baggage item information as baggage data.

The interior space management system 1 has a memory unit 14, which is designed to store and provide historical data and the baggage data. The historical data can include flight information such as flight distance, date, time of day, number of passengers, status of passengers, etc., as well as the corresponding occupancy information captured by the acquisition unit 9. For this purpose, the acquisition unit 9 and the data processing unit 12 are connected to the memory unit 14 for signal communication. For example, the memory unit 14 is designed as an online-based memory, e.g. a cloud, with the acquisition unit 9 and the data processing unit 12 being connected to the memory unit 13 via the internet. For the evaluation of the image file, the memory unit 13, or alternatively the data processing unit 12, can comprise a software module 13, which is designed as an application software program, for example. The software module 13 can also provide a corresponding user interface for the data processing unit 12, via which the different pieces of baggage item information can be entered.

In the exemplary embodiment shown, the memory unit 13 also comprises an analysis module 15, wherein the analysis module 15 is designed to determine both a current and a future utilization of the aircraft 2 on the basis of the historical data and/or the baggage data. The analysis module 15 is preferably designed as an Al module, wherein the Al module calculates a prediction for a future occupancy of the interior regions, in particular of the stowage compartment sections 7 and the seats 5, based on the historical data. For example, the analysis module 15 determines the prediction in relation to the current flight distance and/or the flight duration. In addition, the analysis module 15 can determine an optimal distribution of the baggage items 8 in the stowage compartment arrangement 6 on the basis of the prediction. Alternatively or as an additional option, the analysis module 15 can determine an optimal distribution of the seats 5 on the basis of the prediction.

The interior space management system 1 has a control unit 16 which is used to control and/or distribute the interior regions, in particular the stowage compartment sections 7 and/or seats 5, in the interior space 3 of the aircraft 2 on the basis of historical data and/or the baggage data. The control unit 14 can form an integral part of an on-board electronics of the aircraft 2 or be connected to it via the internet. In particular, the analysis module 15 is designed to activate the control unit 16 in order, for example, to control and/or manage the allocation of seats 5 in relation to the baggage item 8, the availability of the stowage compartment sections 7 and/or an optimal load distribution in the interior space 3.

For this purpose, the control unit 16 can control, for example, a display device, e.g. a display in the interior space 3 of the aeroplane 2, in order to indicate to the passengers or the crew where free interior regions are still available. Alternatively or as an additional option, however, the control unit 16 can also control the passenger's data processing unit 12 to indicate to the passenger his/her associated stowage compartment section 7 and/or his/her corresponding seat 5. Thus, an intelligent stowage compartment management is proposed, which optimizes the boarding process and at the same time a utilization of the stowage compartment sections 7.

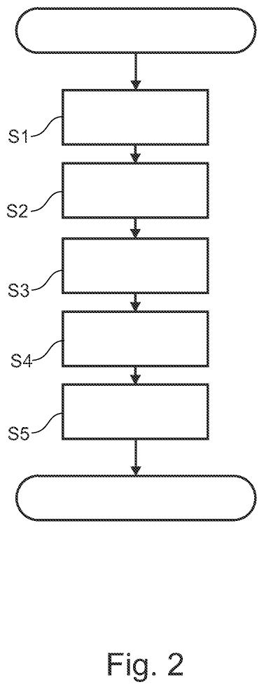

FIG. 2 shows a schematic flowchart of a method for optimized allocation of seats for the interior space management system 1, as described in FIG. 1.

In a first step S1, before the boarding process the baggage item information is captured by the customer/passenger using the data processing unit 12. In order to determine the current size of the baggage item, an image file is recorded as baggage item information of the baggage item 8 and, together with the additional pieces of baggage item information, is transferred to the memory unit 14 as the baggage data. The current baggage item size is determined by the software module 13 by evaluating the image file by means of the software module 13.

In a second step S2, before and during the boarding process, the degree of occupancy of the stowage compartment sections 7 is captured and the free stowage compartment sections 7 are determined. For this purpose, for example, the current occupancy information captured by the acquisition unit 9 and/or previous occupancy information of the stowage compartment sections 7 stored in the memory unit 14 can be evaluated by the analysis module 15.

In a third step S3, before and during the boarding process the analysis module 15 determines an optimal distribution of the baggage items 8 in the stowage compartment arrangement 6 as a function of the free stowage compartment sections 7, based on the baggage data and the historical data.

In a fourth step S4, before and during the boarding process the analysis module 15 calculates an optimal boarding time as a function of the free stowage compartment sections 7, based on the baggage data and the historical data.

In a fifth step S5, before and during the boarding process the analysis module 15 calculates an optimal distribution of the seats 5 as a function of the free stowage compartment sections 7, based on the baggage data and the historical data.

The control unit 16 is then activated by the analysis module 15 in order to control the passengers and/or the baggage items 8 as a function of the optimal baggage distribution, the optimal boarding time and the optimal seat distribution. For this purpose, the control unit 16 can control the display device or the data acquisition unit 12.

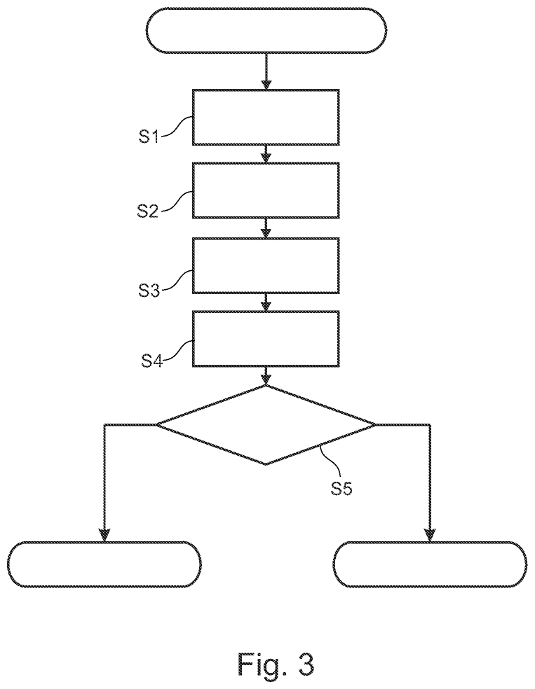

FIG. 3 shows a further schematic flowchart of a method for optimizing baggage compartment costs using the interior space management system 1, as described in FIG. 1.

In a first step S1, before the boarding process the analysis module 15 determines an expected utilization of the stowage compartment sections 7 as a function of the flight distance and/or the flight duration on the basis of the baggage data and the historical data.

In a second step S2, the control unit 16 and/or the data processing unit 12 is/are activated by the analysis module 15 to issue a message, e.g. “Check-in notice” to the customer/passenger, wherein the message includes information regarding a possible number of baggage items 8. Optionally, the message can also comprise information regarding the current and/or expected utilization of the interior space 3, in particular the stowage compartment arrangement 6.

In a third step S3, the current carry-on baggage costs per person are determined depending on the baggage data and/or the historical data, and in a fourth step S4 the analysis module 15 calculates a price offer for the customer/passenger based on the carry-on baggage costs.

In a fifth step S5, the customer/passenger is queried as to whether they accept the price offered. If the price offer is accepted, the customer/passenger will be assigned a seat 5 and associated stowage compartment section 7. If the price offer is rejected, the customer/passenger will be assigned a seat 5 without a stowage compartment section 7.

Thus, a reliable occupancy of the stowage compartment sections 7 can be determined and offered as a new service for the operation of the aircraft 2. In addition, it is possible for the airline to offer this improved service for a fee in order to optimize the commercial situation in this regard.

### LIST OF REFERENCE SIGNS

1 interior space management system
2 aircraft
3 interior space
4 seating arrangement
5 seats
6 stowage compartment arrangement
7 stowage compartment section
8 baggage item
9 acquisition unit
10 optical sensor
11 weight sensor
12 data processing unit
13 software module
14 memory unit
15 analysis module
16 control unit
E acquisition region
S1-S5 method steps

What is claimed is:

1. An interior space management system for an aircraft, wherein the aircraft has a stowage compartment arrangement, wherein the stowage compartment arrangement has a plurality of stowage compartment sections, each holding one or more baggage items,
having a control unit,
wherein the control unit is designed to control and/or manage a distribution of interior regions of an interior space of the aircraft,
wherein
the control unit is designed to control and/or manage an occupancy of the stowage compartment sections as interior regions on the basis of historical data of the aircraft and/or on the basis of baggage data of the baggage items.

2. The interior space management system according to claim 1, wherein the historical data comprise information on the occupancy of the individual stowage compartment sections and/or flight information of the aircraft.

3. The interior space management system according to claim 2, comprising an acquisition unit, wherein the acquisition unit is designed to capture occupancy information from at least one of the stowage compartment sections, wherein in order to transmit the occupancy information the acquisition unit is directly or indirectly connected to the control unit for signal communication.

4. The interior space management system according to claim 1, further comprising a memory unit, wherein for each flight the associated historical data is stored and/or can be stored in the memory unit, wherein in order to transmit the historical data the memory unit is directly or indirectly connected to the control unit for signal communication.

5. The interior space management system according to claim 1, further comprising a data processing unit, wherein the data processing unit is designed to capture baggage item information of the baggage item to be stowed and to provide the baggage item information as the baggage data, wherein in order to transmit the baggage data the data processing unit is or can be directly or indirectly connected to the control unit.

6. The interior space management system according to claim 5, wherein the data processing unit has a camera, wherein the camera is designed to record an image file of the baggage item as baggage item information.

7. The interior space management system according to claim 6, wherein the data processing unit or the memory unit has a software module, wherein the software module is designed to determine a dimension of the baggage item as baggage item information by means of an evaluation of the image file.

8. The interior space management system according to claim 5, wherein the data processing unit is designed as a portable data processing unit.

9. The interior space management system according to claim 8, wherein said portable data processing unit is a smartphone or tablet.

10. The interior space management system according to claim 1, further comprising an analysis module, wherein the analysis module is designed to determine a utilization of the aircraft on the basis of the historical data and/or the baggage data.

11. The interior space management system according to claim 10, wherein the analysis module is designed as an Al module, wherein the Al module is designed to predict a future utilization of the aircraft on the basis of the historical data and/or the baggage data.

12. The interior space management system according to claim 1, wherein the aircraft has a seating arrangement, wherein the seating arrangement has a plurality of seats as interior regions, wherein the control unit is designed to control and/or manage an allocation of the seats on the basis of the historical data and/or on the basis of the baggage data.

13. An aircraft comprising the interior space management system according to claim 1.

14. A method for controlling the interior space management system according to claim 1, in which a distribution of the interior space regions of the interior space of the aircraft is controlled and/or managed by means of the control unit, wherein on the basis of the historical data of the aircraft and/or on the basis of the baggage data of the baggage items, an occupancy of the stowage compartment sections of the stowage compartment arrangement is controlled and/or managed by the control unit.

15. The method according to claim 14, wherein current baggage information of a baggage item is captured by means of the data processing unit and that current occupancy information of the stowage compartment sections is captured by means of the acquisition unit, wherein on the basis of the current baggage information and/or the current occupancy information, an optimal baggage item distribution and/or optimal boarding time and/or an optimal seat distribution is determined by the analysis module and controlled by the control unit.

16. The method according to claim 14, wherein on the basis of the historical data, a prediction of a future utilization of the aircraft is calculated by the Al module, wherein on the basis of the prediction an optimal baggage item distribution and/or an optimal boarding time and/or an optimal seat distribution is/are determined by the Al module and controlled by the control unit.
